(19) United States
(12) Patent Application Publication
(10) Pub. No.: US 2017/0039387 A1
(43) Pub. Date: Feb. 9, 2017

(54) METHOD AND SYSTEM FOR DIFFERENTIATED PRIVACY PROTECTION

(71) Applicant: AGT INTERNATIONAL GMBH, Zurich (CH)

(72) Inventors: Alessandro LEONARDI, Darmstadt (DE); Konstantinos MATHIOUDAKIS, Darmstadt (DE); Alexander WIESMAIER, Ober-Ramstadt (DE); Panayotis KIKIRAS, Darmstadt (DE)

(21) Appl. No.: 14/816,251

(22) Filed: Aug. 3, 2015

(51) Int. Cl. G06F 21/62; H04L 29/06

(52) U.S. Cl. CPC G06F 21/6245; H04L 63/0861

(57) ABSTRACT

A computer-implemented method, computerized apparatus and computer program for receiving and processing user requests, the method comprising: receiving a request for content, the request associated with user credentials; determining a policy associated with the user, in accordance with the user credentials; receiving the content and metadata associated with the content; obtaining a part of the content to be masked; creating an overlay of the content in accordance with the policy and with the metadata, the overlay masking a part of the content; and associating the overlay with the content, such that the part of the content is not available to the user.

### TECHNICAL FIELD

The present disclosure relates to receiving multi-media in general, and to a method and system for protecting the privacy of captured people or objects, in particular.

### BACKGROUND

In today's environment, many public as well as private areas around the world are being continuously or intermittently captured by surveillance devices such as cameras and in particular video cameras, voice capture devices, or the like.

The footage produced by these capturing devices may prove useful for a multiplicity of purposes.

However, this capturing may violate the privacy of people or organizations, for example people captured walking in a street in which a crime is committed and later investigated, people driving a car whose license plate is captured at a particular location, or the like.

References considered to be relevant as background to the presently disclosed subject matter are listed below.

US 2014/0023248 discloses an apparatus and method protecting leakage of privacy information by detecting a specific person using a face recognition technology from a video image stored in a video surveillance system and performing privacy masking or mosaic processing on a face of the specific person or faces of other people.

US2007/0296817 describes a video surveillance system which is composed of three key components 1—smart camera(s), 2—server(s), 3—client(s), connected through IP-networks in wired or wireless configurations. The system has been designed so as to protect the privacy of people and goods under surveillance. Smart cameras are based on JPEG 2000 compression where an analysis module allows for efficient use of security tools for the purpose of scrambling, and event detection. The analysis is also used in order to provide a better quality in regions of the interest in the scene. Compressed video streams leaving the camera(s) are scrambled and signed for the purpose of privacy and data integrity verification using JPSEC compliant methods. The same bit stream is also protected based on JPWL compliant methods for robustness to transmission errors. The operations of the smart camera are optimized in order to provide the best compromise in terms of perceived visual quality of the decoded video, versus the amount of power consumption. The smart camera(s) can be wireless in both power and communication connections. The server(s) receive(s), store(s), manage(s) and dispatch(es) the video sequences on wired and wireless channels to a variety of clients and users with different device capabilities, channel characteristics and preferences. Use of seamless scalable coding of video sequences prevents any need for transcoding operations at any point in the system.

US2005/0129272 proposes a video monitoring system, which is used to mask objects in a monitored scene that involve the privacy of an individual. Such objects include vehicle license plates or the person himself An unmasking occurs when proof of legitimacy is entered. In a modification, a combination of a stationary camera and a moving camera also permits the masking of individual objects in the monitored scene.

US2011/0085035 discloses an apparatus for protecting privacy information of a surveillance image includes a key management unit for generating and managing keys used to unmask a masked input image; an input image processing unit for unmasking the input image using the keys, decoding the unmasked input image to acquire an uncompressed image data, and then applying a second masking on an area containing privacy information of the image data. Further, the apparatus for protecting the privacy information of the surveillance image includes an image recording unit for encoding the image data to which the second masking has been applied to store the encoded image data.

“Privacy Protected Surveillance Using Secure Visual Object Coding” by K. Martin and K. Plataniotis, in IEEE Transactions On Circuits And Systems For Video Technology, Vol. 18, No. 8, August 2008, presents the Secure Shape and Texture SPIHT (SecST-SPIHT) scheme for secure coding of arbitrarily shaped visual objects. The scheme can be employed in a privacy protected surveillance system, whereby visual objects are encrypted so that the content is only available to authorized personnel with the correct decryption key. The secure visual object coder employs shape and texture set partitioning in hierarchical trees (ST-SPIHT) along with a novel selective encryption scheme for efficient, secure storage and transmission of visual object shape and textures. The encryption is performed in the compressed domain and does not affect the rate-distortion performance of the coder. A separate parameter for each encrypted object controls the strength of the encryption versus required processing overhead. Security analyses are provided, demonstrating the confidentiality of both the encrypted and unencrypted portions of the secured output bit-stream, effectively securing the entire object shape and texture content. Experimental results showed that no object details are revealed to attackers who do not possess the correct decryption key. Using typical parameter values and output bit-rates, the SecST-SPIHT coder is shown to require encryption on less than 5% of the output bit-stream, a significant reduction in computational overhead compared to “whole content” encryption schemes.

Acknowledgement of the above references herein is not to be inferred as meaning that these are in any way relevant to the patentability of the presently disclosed subject matter.

Some known methods for protecting the privacy of people or objects captured in the footage include detecting the face of a specific person in one or more video images stored in a video surveillance system, and masking, mosaic processing, pixelating, or scrambling the faces of other persons or other areas in the image. In some of these approaches the content to be protected is irreversibly masked, while in other the masking may be removed. However such approaches do not consider the privileges of the viewer, or the different circumstances in which different parts of the images may have to be masked.

Other approaches selectively mask parts of an image based upon known characteristics such as texture, such that the parts may be de-masked given the appropriate decryption key.

Referring now to FIG. 1, showing a schematic block diagram of prior art systems for providing content to a client by a server.

Client 104 may be a device or an application, for example an application displaying images or video streams, playing audio stream, providing text, or the like.

Client 104 issues one or more requests to service provider 112, such as a request to retrieve an audio or video stream, text, or the like.

Prior to being received by service provider 112, the requests are handled by services 108 which may be internal or external, such as authentication services. The handled requests are then sent to service provider 112, such as a server or a service associated with a capture device or a storage device, and service provider 112 delivers the required responses back to client 104, for example the audio or video stream. Prior to being delivered to client 104, the responses are handled by service 116, which may be internal or external, such as a response verification service.

Client 104 may then use the delivered service, for example display the video, play the audio, or the like.

### BRIEF SUMMARY

One aspect of the invention is a computer-implemented method comprising the steps of: receiving a request for content, the request associated with user credentials; determining a policy associated with the user, in accordance with the user credentials; receiving the content and metadata associated with the content; obtaining a part of the content to be masked; creating an overlay of the content in accordance with the policy and with the metadata, the overlay masking a part of the content; and associating the overlay with the content, such that the part of the content is not available to the user. Within the method, the policy is optionally also associated with the request. The method may further comprise determining the part of the content to be masked. The method may further comprise providing the content to the user. Within the method, the data optionally comprises one or more images, and the metadata comprises a recognized face within an image. Within the method, the data optionally comprises an audio stream, and the metadata comprises a segment within the audio stream. Within the method, the credentials optionally comprise privileges of the user. The method may further comprise recognizing the metadata within the data based upon privacy-related information. The method is optionally performed online in response to a user issuing a request. Within the method, said determining the policy, said obtaining, or said creating are optionally performed offline and provided to the user upon request, subject to a policy applicable for the user being in compliance with the policy associated with the overlay. Within the method, the content optionally is available to another user having different credentials.

Another aspect of the invention relates to a computerized apparatus having a processor, the apparatus comprising: a privacy engine configured to: receive a request for content, the request associated with user credentials; determine a policy associated with the user, in accordance with the user credentials; receive the content and metadata associated with the content; obtain a part of the content to be masked; create an overlay of the content in accordance with the policy and with the metadata, the overlay masking a part of the content; and associate the overlay with the content, such that the part of the content is not available to the user. Within the computerized apparatus, the policy is optionally also associated with the request. The computerized apparatus may further comprise an access control database associated with the privacy engine and further configured to provide the policy. The computerized apparatus may further comprise a decision engine associated with the privacy engine and further configured to determine the part of the content to be masked in accordance with the metadata and the policy. The computerized apparatus may further comprise an authentication module associated with the privacy engine and further configured to check the user credentials. Within the computerized apparatus, the data optionally comprises one or more images, and the metadata comprises a recognized face within an image. The computerized apparatus may further comprise a face recognition engine associated with the privacy engine and further configured to recognize the face within the at least one image. Within the computerized apparatus, the data optionally comprises an audio stream. The computerized apparatus may further comprise a voice recognition engine associated with the privacy engine and further configured to recognize a part within the audio stream. Within the computerized apparatus, the content is optionally available to another user having different credentials.

Yet another aspect of the invention relates to a computer program product comprising a computer readable storage medium retaining program instructions, which program instructions when read by a processor, cause the processor to perform a method comprising: receiving a request for content, the request associated with user credentials; determining a policy associated with the user, in accordance with the user credentials; receiving the content and metadata associated with the content; obtaining a part of the content to be masked; creating an overlay of the content in accordance with the policy and with the metadata, the overlay masking a part of the content; and associating the overlay with the content, such that the part of the content is not available to the user.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic block diagram of prior art systems for providing services by a server to a client;

FIG. 2 shows a schematic block diagram of a system for providing data or services by a server to a client, in accordance with some exemplary embodiments of the disclosed subject matter;

FIG. 3 shows a detailed block diagram of a system for providing data or services from a data source to a client, in accordance with some exemplary embodiments of the disclosed subject matter;

FIG. 4 shows a flowchart diagram of a method for providing data or services to a client, in accordance with some exemplary embodiments of the disclosed subject matter;

FIG. 5A and FIG. 5B are flowchart diagrams of an embodiment of a method for providing data or services to a client, in accordance with some exemplary embodiments of the disclosed subject matter;

FIG. 6 is an illustration of an exemplary entry of a privacy-related database, in accordance with some exemplary embodiments of the disclosed subject matter; and

FIG. 7 is a block diagram of an apparatus in accordance with some exemplary embodiments of the disclosed subject matter.

### DETAILED DESCRIPTION

One technical problem relates to the need for providing differentiated privacy for people or organizations associated with elements captured by a capture device, such as captured individuals, objects, or the like, in order to prevent privacy information from being leaked. For example, a person captured or recorded in a situation may have the right to privacy, such that he will not be seen or heard when the recording is played. However, the right not to be seen as absolute but rather relative. For example, a person may have the right not to be seen or heard by a first person such as a policeman playing a recording, but the person may not have that right when an officer is playing the same recording. In another example, the person may avoid being seen or heard when he is a witness to a crime but may not have such right when he is a suspect in the crime. Thus, it is required to mask or otherwise conceal a person or an object in captured footage based on the identity or another characteristic of the person or object, as well as on the identity of the user and the policies applicable to the viewer and to the person or object.

Some known methods include detecting the face of a specific person in one or more video images stored in a video surveillance system, and masking, mosaic processing, pixelating, or scrambling the faces of other persons or other areas in the image. In some of these approaches the content to be protected is irreversibly masked, while in other the masking may be removed. However such approaches do not consider the privileges of the viewer, or the different circumstances in which different parts of the images may have to be masked.

Other approaches selectively mask parts of an image based upon known characteristics such as texture, such that the parts may be de-masked given the appropriate decryption key.

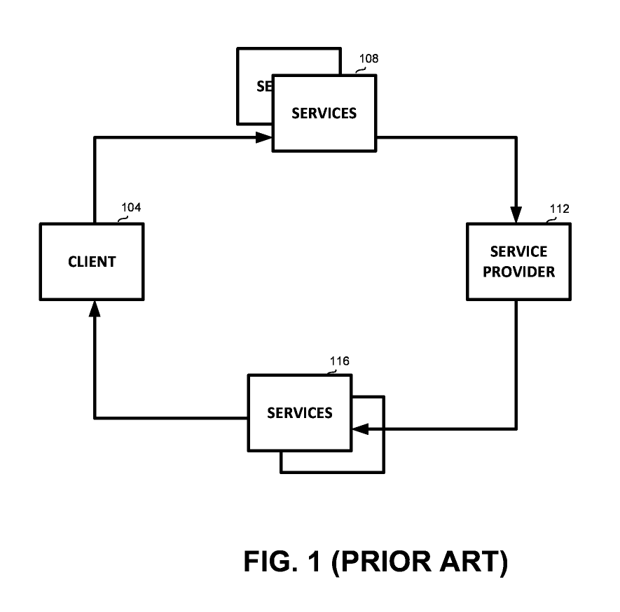

In the configuration shown in FIG. 1 above, in which request or responses flow between client 104 and service provider 112, there is no filtering of the delivered services in accordance with the identity or privileges of the client or the user of the client.

Thus none of the existing solutions suggests a real-time approach for selective masking of content based upon the captured person or object as well as the viewer privileges, such that multiple viewers having different privileges can receive the content simultaneously or at small time intervals.

One technical solution comprises the provisioning of a privacy engine for receiving service requests from users, retrieving a relevant policy for the user while optionally taking into account the request, receiving the required content from one or more relevant servers, partially masking the content in accordance with the policy and with the persons or objects appearing in the content, and providing the masked content to the user.

Thus, the users do not communicate directly (or via a privilege-oblivious application) with the servers as in conventional systems, but rather via the privacy engine.

In some exemplary embodiments, the privacy engine may comprise one or more components for performing steps such as but not limited to: authenticating the user's privileges, retrieving the applicable policy for the user, determining which parts of the data are to be masked, masking the data, and providing the masked data to the user.

The privacy engine may operate online, for example in real-time or near-real-time. The privacy engine may operate on the data as it is being captured or as received from a storage device.

Alternatively, the privacy engine may operate offline and prepare one or more masks associated with various policies. Then, when a specific user issues a request, the masked data relevant to the policy associated with each specific user is available and may be used.

One technical effect of utilizing the disclosed subject matter is the provisioning of a method and system for providing differentiated privacy to people or objects captured by capture devices. The people or objects may be masked in the recordings such that only users having adequate privileges may see or hear them.

The system and method may operate in real-time, thus providing for varying privileges and different policies associating the users with the content they are allowed or not allowed to receive.

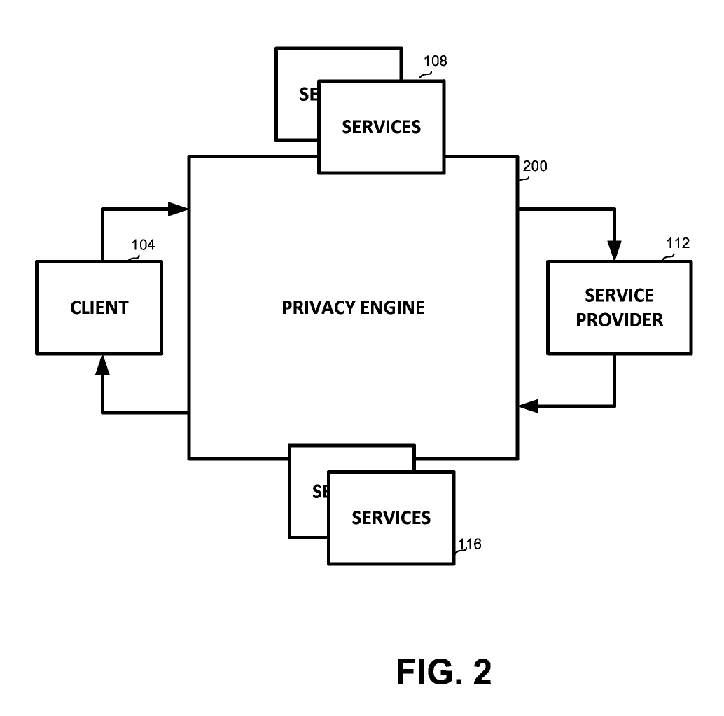

Referring now to FIG. 2, showing a schematic block diagram of a system for providing data or services by a server to a client, in accordance with some exemplary embodiments of the disclosed subject matter.

Client 104, services 108 and 116, and service provider 112 are as in FIG. 1. However, the request is not transmitted from client 104 to service provider 112. Rather it is intercepted by privacy engine 200, which may use internal or 3^{rd} party service 108, for example to check the credentials and privileges of client 104. Privacy engine 200 then transmits to service provider 112 a request that may comprise information related to the credentials, privileges, or policy applicable for client 104.

The response provided by service provider 112, for example the video stream, may then also be intercepted by privacy engine 200, which may modify the data, for example masks the required parts, in accordance with the policy, and transmits the results to client 104. Privacy engine 200 may use internal or 3^{rd} party services 116, for example for validating the response before it is provided to client 104.

Privacy engine 200 may be executed by the same computing platform as client 104, the same computing platform as server 112 or by any other computing platform. Depending on the location of privacy engine 200, the required bandwidth for transmitting the service may be reduced due to the transmittal of masked parts instead of the original high quality parts.

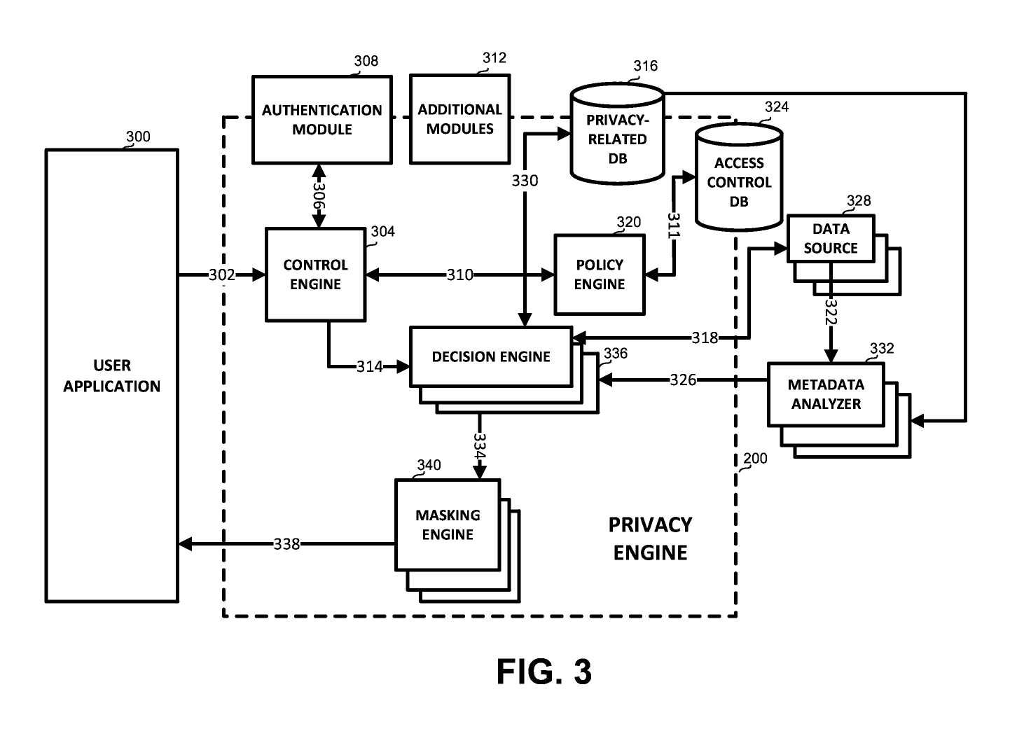

Referring now to FIG. 3, showing a detailed block diagram of a system for providing data from a data source to a client, in accordance with some exemplary embodiments of the disclosed subject matter.

FIG. 3 shows an exemplary embodiment of the schematic environment of FIG. 2. User application 300 is an example of client 104, while data source 328 and metadata analyzer 332 detailed below constitute an example of server 112.

It will be appreciated that data source 328 may comprise captured content or other stored data, but may also provide for provisioning services, such as web pages or other documents created on the fly, or other services.

Privacy engine 200 may receive from user application 300 a request 302 for content. Request 302 may be received by control engine 304 responsible for the data and control flow within privacy engine 200. Request 302 may comprise or be associated with credentials of a user using user application 300, such as name, role, or the like. Request 302 may also comprise information related to the request such as a name or an ID of a person to be displayed, or the like.

Control engine 304, which may be comprised in privacy engine 200, may request and receive authentication for the credentials or identity of the user, from authentication module 308. Authentication module 308 may authenticate the identity of the user, for example by connecting to an independent source, comparing control numbers or the like. Authentication module 308 may or may not be comprised in privacy engine 200.

It will be appreciated that one or more additional modules 312, which may or may not be comprised within privacy engine 200, may be used for various purposes associated with the requestor the response, whether these modules are fully or partially implemented as part of privacy engine 200, or not.

Control engine 304 may also request and receive a policy 310 associated with the user, from policy engine 320. Policy engine 320 may receive the identity or credentials of the user from control engine 304, and may communicate with an access control database 324 for retrieving information 311 applicable to the user, such as access level applicable for the user. Information 311 may be personal, e.g. retrieved by name or ID. Alternatively or additionally, Information 311 may be role-dependent, group-dependent, or the like. Role-dependent may relate to the policy being dependent on the role of a user, such as policeman, officer, HR person, marketing person, etc. Group-dependent may relate to the policy being dependent on a group with which the user is associated, such as investigation team, HR group, marketing group, or the like. Information 311 may also be a combination of two or more of the above.

Policy engine 320 may create policy 310 based on received information 311 and possibly on additional data, such as the specific request by the user, date or time, or the like. For example, a user may have a predetermined permission levels, but may also be allowed or disallowed to view specific people or objects, possibly at specific dates or times, as expressed in the issued request and incorporated into policy 310. Thus, the permissions of the user as expressed in policy 310 may depend on the user credentials and may also depend on the request and optionally on other factors. Policy engine 320 may be comprised in privacy engine 200.

Control engine 304 may send request 314 with the authenticated credentials and with policy 310 to decision engine 336.

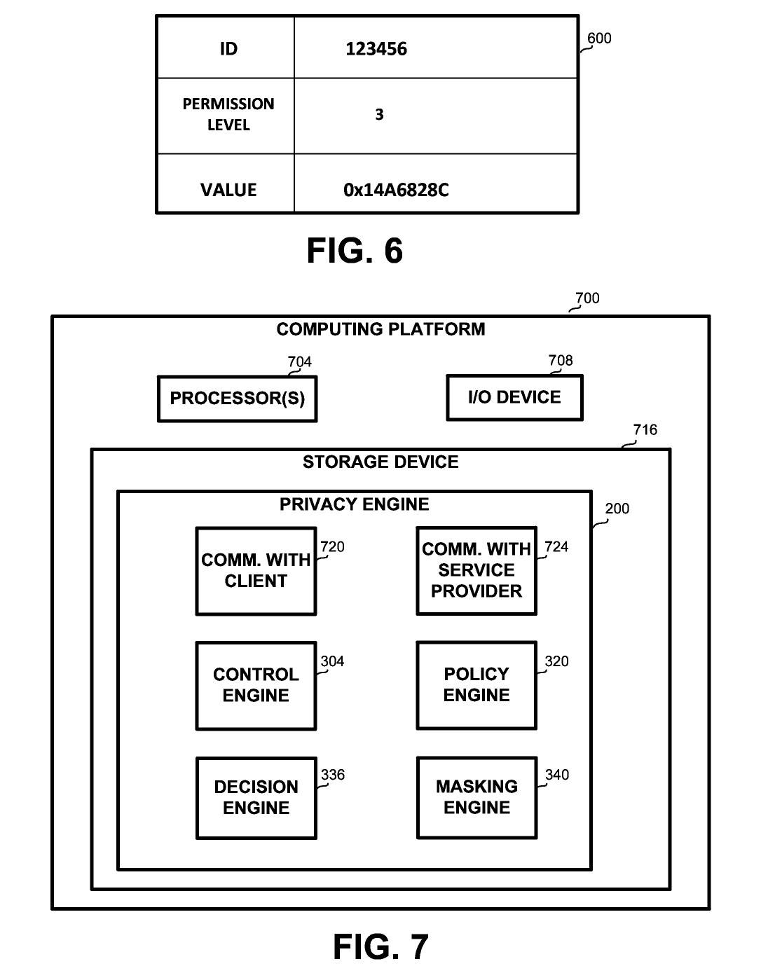

Decision engine 336 may also receive information 330 from privacy-related database 316. Privacy-related database 316 may comprise information related to of persons or objects to be displayed or not to be displayed, including for example ID, a picture or another characteristic, and a permission level. For example, in the case of two levels, privacy-related database 316 may be implemented as a blacklist/whitelist database. For example, in a commercial organization, a whitelist may include the employee details and pictures which any person from within the organization may see, while a blacklist may include customer details and pictures which only people having specific privileges may see. Privacy-related database 316 is further detailed in association with FIG. 6 below.

Decision engine 336 may send request 318 and privacy-related information 330 to data source 328 which stores the content to be provided to the user. Data source 328 may be, for example a video capture device, an audio capture device, a database storing captured content, a text collection, or the like.

In other exemplary embodiments, privacy-related information 330 may be provided by privacy-related database 316 directly to metadata analyzer 332, rather than via decision engine 336.

The required content 322 with privacy-related information 330 may be sent to metadata analyzer 332. Metadata analyzer 332 may be, for example, a face recognition engine, a voice recognition engine, and/or the like. In the embodiment in which metadata analyzer 332 is a face recognition engine or an object recognition engine, it may recognize faces or objects within the video stream provided by data source 328, and may associate one or more of the recognized faces or objects with entities from privacy-related information 330.

The content as retrieved from data source 328 with the information from metadata analyzer 332, together referenced 326, may thus comprise for example video content with one or more indications to locations in one or more images, and whether each such location is associated with a known person or object and the permission level associated with the person or object. In some embodiments, information 326 may also comprise location indications associated with unrecognized faces, for which the decision whether to mask them or not may be made depending on the policy for the specific user.

Decision engine 336 may receive content and metadata 326, and in accordance with policy 310 may determine which areas of the data should be masked. For example, if a user has privileges for permission levels 1-4, all identified faces having permission levels that fall within the range of 1-4 will be displayed while faces associated with other permission levels (i.e., 5 and above) will be masked. In another example in which privacy-related database 316 comprises only a whitelist referring to employees of an organization and a blacklist comprising only customers of an organization, it may be determined that a person from a human resources department of the organization having whitelist permission will see only the faces of people that appear in the whitelist, e.g. the employees, while a person from marketing having blacklist permission will see only the faces of the customers. In another example, for a minor policeman it may be determined that all areas associated with whitelist persons or objects, as well as one or more areas associated with a specific name or ID indicated in request 302 have to be unmasked, and all other areas associated with persons or objects from the blacklist have to be masked. For a very senior policeman having full privileges, it may be determined that no area of the content should be masked. It will be appreciated that the invention is not bound by the examples above. Decision engine 336 may be comprised in privacy engine 200.

In some embodiments, for example if privacy engine 200 is implemented as part of data source 328 such as a video camera, it may fully or partially operate on the original data as captured to eliminate sending unmasked content over a communication channel, while in other cases for example if data source 328 is a storage device it may operate on a copy of the data.

The content and decisions 334 as taken by decision engine 336 may then be sent to masking engine 340 for performing the masking, for example by creating an overlay of the data, for example each image, and irremovably associating the overlay with the image, for example by replacing parts of the image with masked parts. Overlaid image 338 may then be provided to user application 300 and may be displayed. Masking engine 340 may be comprised in privacy engine 200.

In some embodiments, the term irremovably relates to masking the information in an unrecoverable manner, for example providing an image with some areas set to all zeros instead of the original values, such that the original information cannot be retrieved. In another embodiment, the term irremovable may relate to the masking being irremovable by a user having specific user credentials and privileges. For example, the information may be encoded using a private/public key scheme, such that the user's key does not enable decoding some of the information, but the user's supervisor using the supervisor's key may be able to decode the full information. In further embodiments, the information may be masked under certain conditions, for example the information may be masked with a key and with a date or time indication, such that the information is unrecoverable until the particular time or date, but is recoverable afterwards. Similarly, location-based encoding may also be used.

The term irremovably relates to the user, having the specific user credentials and privileges, not being able to retrieve the masked content.

It will be appreciated that each of decision engine 336, data source 328, metadata analyzer 332 and masking engine 340 may have multiple instances, in accordance with the number of supported services. For example, if a user may request a video stream or an audio stream, there may be two instances of each such engine. If as user may request any of three types of video and any of two types of audio, then there may be five instances of each such engine, each handling the relevant media type. It will be appreciated that other types of services may be provided by appropriate engines, such as provisioning text, images, or the like.

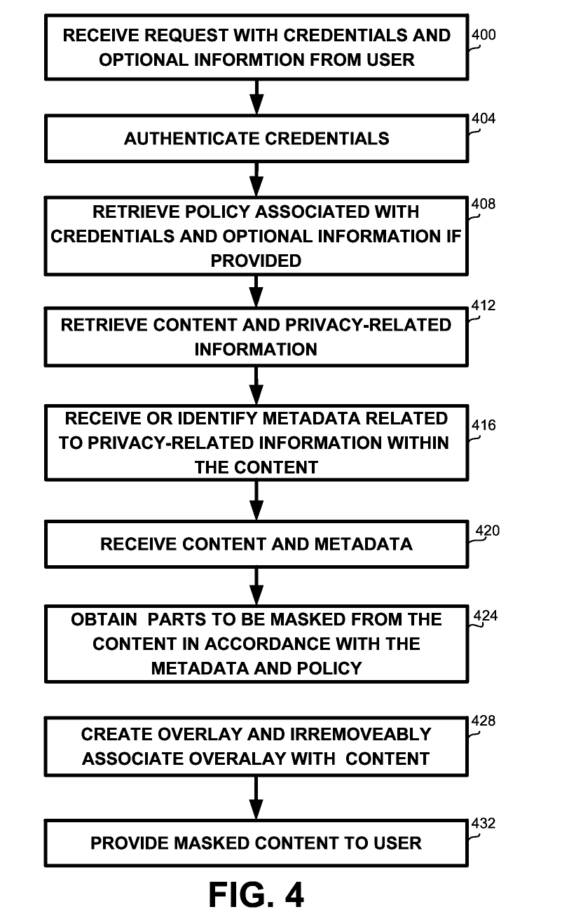

Referring now to FIG. 4, showing a flowchart diagram of a method for providing data or services to a client, in accordance with some exemplary embodiments of the disclosed subject matter.

On step 400, a request may be received from a user, the request indicating credentials of the user and optionally information relates to the content to be received, such as whether a particular person or object should be seen or heard.

On optional step 404, the user credentials may be authenticated.

On step 408, a policy associated with the credentials of the user may be received. The policy may be personal, role-based, group-based, or the like and may initially be retrieved from a storage device. The policy may also be enhanced with information from the request. For example, the policy may relate to people or objects which the user is allowed or forbidden to see. Thus, the policy may depend on the user credentials or the request.

On step 412, the content may be retrieved, as well as information such as privacy-related information. For example, the privacy-related information may include names or identifiers of people or objects, permission levels associated with the people or objects, such as blacklists or whitelists of persons or objects to be displayed or masked, and relevant characteristics of the people or objects upon which they can be identified in the content.

On step 416, metadata associated with the privacy-related information may be identified within the content. For example, faces or objects may be identified within one or more images of a video stream, and may then be associated with names or identifiers of people or objects appearing in the blacklist or whitelist, and similarly for the voice of a person appearing the appearing in the blacklist or whitelist may be identified within an audio stream, or the like. Identifying the metadata may include determining a size and location within an image, a start time and end time within an audio stream, or the like. In alternative embodiments, the relevant parts may be received from an external source, for example a storage device storing content that was already processed in the past.

On step 420 the content and the metadata may be received.

On step 424, it may be obtained which parts of the content, as associated with the metadata may or may not be masked such that the user can or cannot see, hear or otherwise experience it. The parts to be masked depend on the policy applicable for the user as retrieved on step 408. In some embodiments, obtaining the parts to be masked includes determining the parts, while in other embodiments the information may be received from another source.

On step 428, based upon the decisions obtained on step 424, the relevant parts may or may not be masked, for example by creating an overlay of an image, removing or altering parts of an audio stream, or the like.

On step 432 the masked content may be provided to the user, such that the user receives the content but the masked parts are unavailable to the user.

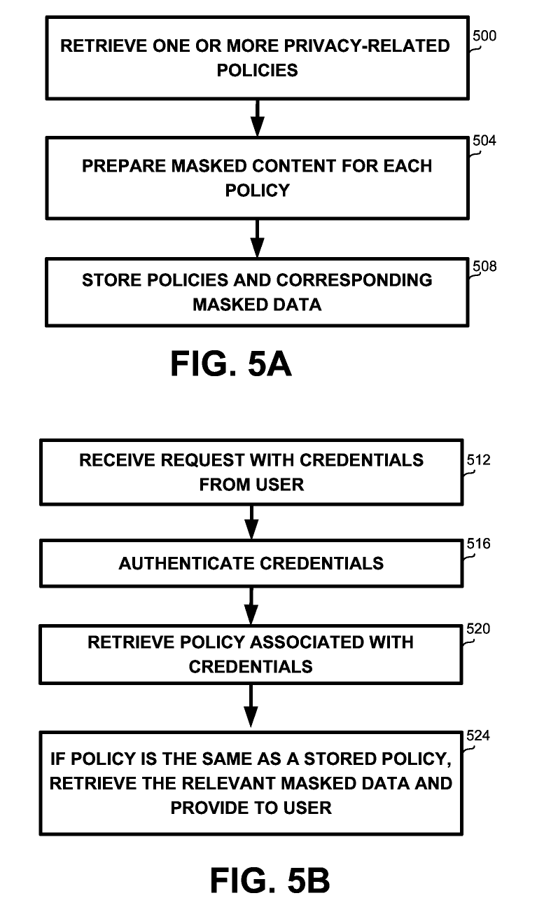

Referring now to FIGS. 5A and 5B, showing flowchart diagrams of another embodiment of a method for providing data from a data source to a client, in accordance with some exemplary embodiments of the disclosed subject matter.

FIG. 5A relates to an offline preparation stage, while FIG. 5B relates to the online stage in which requests are received and handled.

On step 500, one or more privacy-related policies may be retrieved. In the example in a permission system comprising permission levels 1-10, policies may exist which allow users to view objects or persons associated with permission level 1, permission levels 1-2, permission levels 1-3, and so on.

On step 504, the content may be retrieved, and a different masking may be created for each policy. In the example above, a first masked content may be prepared which complies with the policy associated with permission level 1, a second masked content may be prepared which complies with the policy associated with permission levels 1-2, and so on.

On step 508, the masked contents and indication to the associated policies may be stored.

Then in runtime, when a user requests content, the following steps of FIG. 5B may be performed.

On step 512, a request may be received, with user credentials related for example to a person or object to be seen or heard.

On step 516 the user credentials may be authenticated.

On step 520 a policy associated with the user may be retrieved, and on step 524, if the policy is the same as one of the policies for which masking is available, the relevant masked content is retrieved and provided to the user.

In some embodiments, only the face recognition or object recognition may be performed offline, and once a user issues a request, the relevant mask may be generated, associated with the content and provided to the user. This scheme may take longer time between issuing the request and receiving the response than the scheme shown in FIGS. 5A and 5B, but may save storage space. However, in this case the policy applicable to the user may also depend on the specific request, such that specific people of objects to which the user request relates to may also be shown or masked in the provided content.

Referring now to FIG. 6, showing an exemplary entry of a privacy-related database 316. Each entry may have an identifier, such as a name, an ID, or the like; a permission level; and a value. The permission levels may be implemented as an integer, as a value selected from a list, such as allowed/forbidden, black/white, or the like.

The value may be any stored value, such as an image of a face associated with the ID, an image of a license plate, a license plate number, a characteristic value of a face such as one or more hash values or another descriptor of an image, a characteristic of a voice such as a voice model, or the like. The value may be stored in the database, or stored at a location pointed to by the database.

Referring now to FIG. 7, showing a block diagram of an apparatus in accordance with some exemplary embodiments of the disclosed subject matter.

The apparatus comprises computing platform 700, executing privacy engine 200 of FIG. 2.

In some exemplary embodiments, computing platform 700 may comprise a processor 704. Processor 704 may be a Central Processing Unit (CPU), a microprocessor, an electronic circuit, an Integrated Circuit (IC) or the like. Processor 704 may be utilized to perform computations required by computing platform 700 or any of it subcomponents.

In some exemplary embodiments of the disclosed subject matter, computing platform 700 may comprise an Input/Output (I/O) device 708 such as a display, a keyboard, voice input or output device, or the like.

In some exemplary embodiments, computing platform 700 may comprise a storage device 716. Storage device 716 may be a hard disk drive, a Flash disk, a Random Access Memory (RAM), a memory chip, or the like. In some exemplary embodiments, storage device 716 may retain program code operative to cause processor 704 to perform acts associated with any of the subcomponents of computing platform 700. Storage device 716 may also store questions or challenges presented to the driver, known answers to the questions or the driver's answers, driver's score, or the like.

Storage device 716 may comprise one or more components as detailed below, implemented as executables, libraries, static libraries, functions, or any other executable components. In runtime, the components may be loaded to a memory device of computing platform 700, to be executed by processor 704.

Storage device 716 may store privacy engine 200 for carrying out steps of FIG. 4 or FIG. 5A and 5B above.

Privacy engine 200 may comprise communication with client component 720 for receiving a request from a client and providing the content back to the client. The request may be associated with credentials of a user of the apparatus.

Privacy engine 200 may comprise communication with service provider component 724 for sending requests and possibly additional parameters such as permission level information to a service provider such as a data source and metadata analyzer, and receiving responses such as content or indications to areas of the content associated with certain persons or objects.

Storage device 716 may comprise control engine 304 for managing the data and control flow within privacy engine 200; policy engine 320 for determining a policy associated with the user, in accordance with the user credentials; decision engine 336 receiving the content and metadata associated with the content and determining which parts of the content are to be masked; and masking engine 340 for creating an overlay masking the parts of the content in accordance with the policy and with the metadata and irremovably associate the overlay with the content, such that the part of the content is not available to the user, as detailed in association with FIG. 3 above.

Storage device 716 may comprise or be in communication with privacy-related database 316, access control database 324 and possibly additional components.

It will be appreciated that although the system and method are described in association with provisioning of data, they may be applied towards requesting and consuming a service in which part of the service is masked in accordance with privileges of the user and metadata associated with the service.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will be appreciated that components of block diagrams in the disclosure are exemplary only and that additional embodiments may be used. In particular, two or more components may be unified into a smaller number of components, one component may be split into two or more components, functionalities may be divided differently between components, communication channels between components may be different, or the like.

It will be appreciated that components, and in particular the privacy engine described above may comprise components executed by a single computing platform or a multiplicity of operatively connected computing platforms each executing one or more components.

It will also be appreciated that although some elements are described which are associated with different embodiments, the disclosure also covers combinations of such elements into one or more embodiments.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising the steps of:
a. receiving a request for content, the request associated with user credentials;
b. determining a policy associated with the user, in accordance with the user credentials;
c. receiving the content and metadata associated with the content;
d. obtaining a part of the content to be masked;
e. creating an overlay of the content in accordance with the policy and with the metadata, the overlay masking a part of the content; and
f. associating the overlay with the content, such that the part of the content is not available to the user.

2. The method of claim 1 wherein the policy is also associated with the request.

3. The method of claim 1 further comprising determining the part of the content to be masked.

4. The method of claim 1 further comprising providing the content to the user.

5. The method of claim 1, wherein the data comprises at least one image, and the metadata comprises a recognized face within the at least one image.

6. The method of claim 1, wherein the data comprises an audio stream, and the metadata comprises a segment within the audio stream.

7. The method of claim 1, wherein the credentials comprise privileges of the user.

8. The method of claim 1, further comprising recognizing the metadata within the data based upon privacy-related information.

9. The method of claim 1, wherein the method is performed online in response to a user issuing a request.

10. The method of claim 1, wherein steps b, d, or e are performed offline and provided to the user upon request, subject to a policy applicable for the user being in compliance with the policy associated with the overlay.

11. The method of claim 1, wherein the content is available to another user having different credentials.

12. A computerized apparatus having a processor, the apparatus comprising:
a privacy engine configured to:
receive a request for content, the request associated with user credentials;
determine a policy associated with the user, in accordance with the user credentials;
receive the content and metadata associated with the content;
obtain a part of the content to be masked;
create an overlay of the content in accordance with the policy and with the metadata, the overlay masking a part of the content; and
associate the overlay with the content, such that the part of the content is not available to the user.

13. The computerized apparatus of claim 12 wherein the policy is also associated with the request.

14. The computerized apparatus of claim 12 further comprising an access control database associated with the privacy engine and further configured to provide the policy.

15. The computerized apparatus of claim 12 further comprising a decision engine associated with the privacy engine and further configured to determine the part of the content to be masked in accordance with the metadata and the policy.

16. The computerized apparatus of claim 12 further comprising an authentication module associated with the privacy engine and further configured to check the user credentials.

17. The computerized apparatus of claim 12, wherein the data comprises at least one image, and the metadata comprises a recognized face within the at least one image.

18. The computerized apparatus of claim 17, further comprising a face recognition engine associated with the privacy engine and further configured to recognize the face within the at least one image.

19. The computerized apparatus of claim 12, wherein the data comprises an audio stream.

20. The computerized apparatus of claim 19, further comprising a voice recognition engine associated with the privacy engine and further configured to recognize a part within the audio stream.

21. The computerized apparatus of claim 12, wherein the content is available to another user having different credentials.

22. A computer program product comprising a computer readable storage medium retaining program instructions, which program instructions when read by a processor, cause the processor to perform a method comprising:
a. receiving a request for content, the request associated with user credentials;
b. determining a policy associated with the user, in accordance with the user credentials;
c. receiving the content and metadata associated with the content;
d. obtaining a part of the content to be masked;
e. creating an overlay of the content in accordance with the policy and with the metadata, the overlay masking a part of the content; and
f. associating the overlay with the content, such that the part of the content is not available to the user.
